(19) United States
(12) Patent Application Publication
(10) Pub. No.: US 2017/0233035 A1
(43) Pub. Date: Aug. 17, 2017

(54) CRANK-PEDAL MECHANISM FOR BICYCLE

(71) Applicant: ROYALBABY CYCLE BEIJING CO., LTD., Haidian District of Beijing (CN)

(72) Inventor: Tony TONG, Beijing (CN)

(21) Appl. No.: 15/518,752

(22) PCT Filed: Apr. 28, 2015
(86) PCT No.: PCT/CN2015/077661

§ 371 Date: Apr. 12, 2017

(30) Foreign Application Priority Data
Feb. 5, 2015 (CN) 201510058349.5

(51) Int. Cl. B62M 3/16; B62M 3/00

(52) U.S. Cl. CPC B62M 3/16; B62M 3/003; B62M 3/08

(57) ABSTRACT

A quick-mount crank-pedal mechanism for a children bicycle is provided. The quick-mount crank-pedal mechanism is composed of the following two parts including a crank rod and a crank bearing. The crank rod and the crank bearing are fitted with each other. With the mechanism, a pedal is enabled to be in a usable state quickly without using any tools, and a tip of the crank is effectively protected from puncturing through a carton, thereby reducing potential safety hazards.

### TECHNICAL FIELD

The present disclosure relates to a quick-mount crank-pedal mechanism for a children bicycle.

### BACKGROUND

Since a split design is used in the existing art, link structures are relatively complex and need lots of operation procedures. Moreover, a tip of a crank is easy to pierce a carton during transportation. Therefore, a pedal mechanism in the existing art has poor firmness, is easily broken, and has potential safety hazards, and the installation thereof is troublesome.

### SUMMARY

In view of the shortcomings in the above-mentioned problems, the present disclosure provides a quick-mount crank-pedal mechanism for a children bicycle.

In order to achieve the above object, the present disclosure provides a quick-mount crank-pedal mechanism for a children bicycle. The quick-mount crank-pedal mechanism is composed of the following two parts: a crank rod and a crank bearing. The crank rod is configured to be fitted with the crank bearing. A spring protrusion is provided at a tip of the crank rod, and a clamping slot is provided on the crank bearing.

Further, the spring protrusion and the clamping slot are fitted with each other.

Further, a thread mechanism is provided on the crank rod, and a nut mechanism is provided in the crank bearing.

The present disclosure has the following beneficial effects: with the present mechanism, the pedal is enabled to be in a usable state quickly without using any tools, thus a customer is free from trouble in installation; the tip of the crank is effectively protected from puncturing through a carton during transportation, thereby reducing potential safety hazards. The present mechanism has many advantages such as eliminating all complicated procedures and misleading, making the consumer free from confusions, and being firmer.

### BRIEF DESCRIPTION OF DRAWINGS

FIG. 1 is an overall schematic diagram showing a quick-mount crank-pedal mechanism for a children bicycle according to the present disclosure;

FIG. 2 is a separated schematic diagram showing a quick-mount crank-pedal mechanism for a children bicycle according to the present disclosure;

List of Reference numerals: 1 crank rod; 2 crank bearing; 3 protrusion; 4 clamping slot.

### DETAILED DESCRIPTION

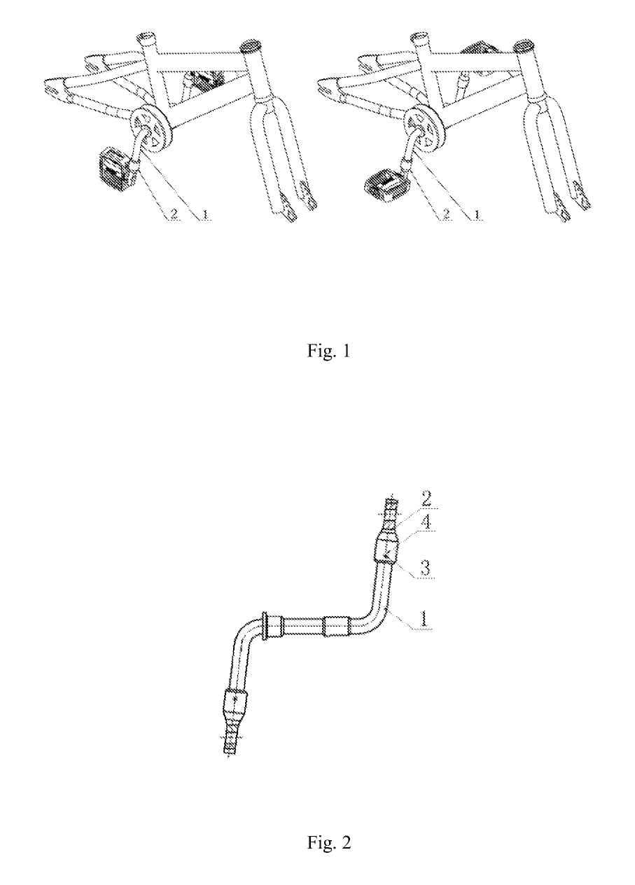

As shown in FIG. 1, the present disclosure relates to a quick-mount crank-pedal mechanism for a children bicycle. The quick-mount crank-pedal mechanism is composed of the following two parts: a crank rod (1) and a crank bearing (2). The crank rod (1) and the crank bearing (2) are fitted with each other. A tip of the crank rod (1) is provided with a spring protrusion (3) which is fitted with a clamping slot (4) provided on the crank bearing (2). Through the present mechanism, the pedal is enabled to be in a usable state quickly without using any tools, thus a customer is free from trouble in installation. Moreover, the tip of the crank is effectively protected from puncturing through a carton, thereby reducing potential safety hazards. The present mechanism has advantages, such as eliminating all complicated procedures and misleading, making the consumers free from confusions, and the present mechanism is firmer.

In specific use, it is only required to rotate the pedal by 90 degrees counterclockwise so as to clamp the spring protrusion (3) provided at the tip of the crank rod (1) into the clamping slot (4) provided on the crank bearing (2). Therefore, it is convenient to use and easy to manipulate, and a regulation effect is good.

The aforementioned is only preferred embodiments of the present disclosure. Those skilled in the art are naturally able to make equivalent changes and modifications which fall in the scope of the present disclosure, after understanding the technical means of the present disclosure according to actual needs and based on the scope of the claims of the present disclosure.

1-3. (canceled)

4. A crank-pedal mechanism for a bicycle, comprising:
a crank-rod;
a crank bearing, wherein the crank bearing and the crank-rod are fitted with each other;
a spring protrusion, provided at a tip of the crank rod; and
a clamping slot, provided on the crank bearing.

5. The crank-pedal mechanism according to claim 1, wherein the spring protrusion and the clamping slot are fitted with each other.

6. The crank-pedal mechanism according to claim 1, wherein a thread mechanism is provided on the crank rod, and a nut mechanism is provided in the crank bearing.
